(19) United States
(12) Patent Application Publication
(10) Pub. No.: US 2021/0357266 A1
(43) Pub. Date: Nov. 18, 2021

(54) INFORMATION PROCESSING APPARATUS, INFORMATION PROCESSING METHOD AND COMPUTER READABLE MEDIUM

(71) Applicant: MITSUBISHI ELECTRIC CORPORATION, Tokyo (JP)

(72) Inventors: Osamu TOYAMA, Tokyo (JP); Shigeru HASHIMOTO, Tokyo (JP); Yohei TSUKAMOTO, Tokyo (JP); Naoki ITO, Tokyo (JP)

(73) Assignee: MITSUBISHI ELECTRIC CORPORATION, Tokyo (JP)

(21) Appl. No.: 17/388,596

(22) Filed: Jul. 29, 2021

Related U.S. Application Data
(63) Continuation of application No. PCT/JP2019/012217, filed on Mar. 22, 2019.

(51) Int. Cl. G06F 9/50; G06F 9/445

(52) U.S. Cl. CPC G06F 9/5061; G06F 9/445

(57) ABSTRACT

A first division unit (501) divides a program into a plurality of block candidates, while permitting a part of processes to coexist in two or more block candidates. A block candidate determination unit (502) determines whether or not the part of the processes coexists in the two or more block candidates among the plurality of block candidates. A scheme selection unit (503) compares, when the part of the processes coexists in the two or more block candidates, an execution time in a parallel execution scheme with an execution time in a shared execution scheme, and selects a scheme with shorter execution time between the parallel execution scheme and the shared execution scheme, the parallel execution scheme causing two or more computers to execute in parallel a coexistence process being the part of the processes coexisting in the two or more block candidates, the shared execution scheme causing one computer to execute the coexistence process and causing the other computer to share an execution result. A second division unit (504) divides the program into a plurality of blocks based on the plurality of block candidates and the selected scheme.

### CROSS REFERENCE TO RELATED APPLICATIONS

This application is a Continuation of PCT International Application No. PCT/JP2019/012217, filed on Mar. 22, 2019, which is hereby expressly incorporated by reference into the present application.

### TECHNICAL FIELD

The present invention relates to a technique for dividing a program.

### BACKGROUND ART

In development of an embedded system using a microcontroller or an LSI (Large-Scale Integration), improvement of execution speed by enhancing a clock frequency in hardware has been getting close to a limit. For this reason, a multi-cores scheme has started being used in which the execution speed is increased by executing a plurality of computers in parallel.

There is a similar tendency also in factory automation, and a method described in Patent Literature 1 and a method described in Patent Literature 2 are devised.

Patent Literature 1 describes a method of shortening an execution time of a program by distributing and executing a sequence program over a plurality of computers (PLC: Programmable Logic Controller), and reducing a processing load of each computer.

Further, Patent Literature 2 describes a method in which a plurality of PLCs are connected with each other via a shared memory and a bus, and a PLC with a spare capacity as to a control amount performs control on behalf of a PLC with no spare capacity as to the control amount, thereby control efficiency of an entire control system is enhanced.

### CITATION LIST

### Patent Literature

Patent Literature 1: WO2017/141332 pamphlet
Patent Literature 1: JP2010-079355A

### SUMMARY OF INVENTION

### Technical Problem

In both the method described in Patent Literature 1 and the method described in Patent Literature 2, it is necessary to share information between computers via the shared memory or the bus in order to perform cooperative operation between the computers. However, since the shared memory and the bus are generally accessed through an interface to the outside of the computer, an access delay is large.

Further, a control subject controlled by each computer is also limited by constraints such as input and output of the computer.

For this reason, even if the program is distributed over the plurality of computers, and the programs are executed by the plurality of computers in cooperation with each other, an overhead becomes large due to the access delay for information sharing and the constraints related to the input and the output. Such an increase in the overhead hinders speed-up by distribution of the program and cooperative execution between the plurality of computers, distribution of the processing load, and an enhancement of the control efficiency.

The present invention is based on consideration toward the mentioned above, and mainly aims to realize efficient division of a program with a small overhead.

### Solution to Problem

An information processing apparatus according to the present invention includes:
a first division unit to divide a program into a plurality of block candidates, while permitting a part of processes in the program to coexist in two or more block candidates;
a block candidate determination unit to determine whether or not the part of the processes in the program coexists in the two or more block candidates among the plurality of block candidates;
a scheme selection unit to compare, when the part of the processes in the program coexists in the two or more block candidates, an execution time to be taken when the program is executed in a parallel execution scheme with an execution time to be taken when the program is executed in a shared execution scheme, and select a scheme with shorter execution time between the parallel execution scheme and the shared execution scheme, the parallel execution scheme causing two or more computers being the same number as the two or more block candidates, to execute in parallel a coexistence process being the part of the processes in the program coexisting in the two or more block candidates, the shared execution scheme causing one computer among the two or more computers to execute the coexistence process and causing the other computer among the two or more computers to share an execution result of the one computer; and
a second division unit to divide the program into a plurality of blocks based on the plurality of block candidates and the scheme selected by the scheme selection unit.

### Advantageous Effects of Invention

In the present invention, a scheme with shorter execution time is selected between a parallel execution scheme and a shared execution scheme. Therefore, according to the present invention, it is possible to realize efficient division of a program with a small overhead.

### BRIEF DESCRIPTION OF DRAWINGS

FIG. 1 is a diagram illustrating a configuration example of a control system (one computer) according to a first embodiment;

FIG. 2 is a diagram illustrating a configuration example of a control system (three computers) according to the first embodiment;

FIG. 3 is a diagram illustrating a functional configuration example of computers according to the first embodiment;

FIG. 4 is a diagram illustrating a program code assignment apparatus according to the first embodiment;

FIG. 5 is a diagram illustrating a hardware configuration example of the program code assignment apparatus according to the first embodiment;

FIG. 6 is a diagram illustrating a functional configuration example of the program code assignment apparatus according to the first embodiment;

FIG. 7 is a flowchart illustrating an outline of operation of the program code assignment apparatus according to the first embodiment;

FIG. 8 is a diagram illustrating an example of program execution order information according to the first embodiment;

FIG. 9 is a diagram illustrating an example of program code division candidates according to the first embodiment;

FIG. 10 is a diagram illustrating a division example of a program code according to the first embodiment;

FIG. 11 is a diagram illustrating an example of the program code division candidates according to the first embodiment;

FIG. 12 is a diagram illustrating a division example of the program code according to the first embodiment;

FIG. 13 is a diagram illustrating examples of fixed execution portions and dynamic execution portions of program codes according to the first embodiment;

FIG. 14 is a flowchart illustrating an operation example of the program code assignment apparatus according to the first embodiment;

FIG. 15 is a flowchart illustrating an operation example of the program code assignment apparatus according to the first embodiment;

FIG. 16 is a flowchart illustrating an operation example of the program code assignment apparatus according to the first embodiment;

FIG. 17 is a flowchart illustrating an operation example of the program code assignment apparatus according to the first embodiment; and

FIG. 18 is a flowchart illustrating an operation example of the computer according to the first embodiment.

### DESCRIPTION OF EMBODIMENTS

Hereinafter, embodiments of the present invention will be described with reference to the drawings. In the following description of the embodiments and the drawings, parts with the same reference numerals indicate the same or corresponding parts.

Further, in the following, a program code is also simply referred to as a program.

### First Embodiment

### ***Premise***

First, a control system that is a premise of the present embodiment will be described.

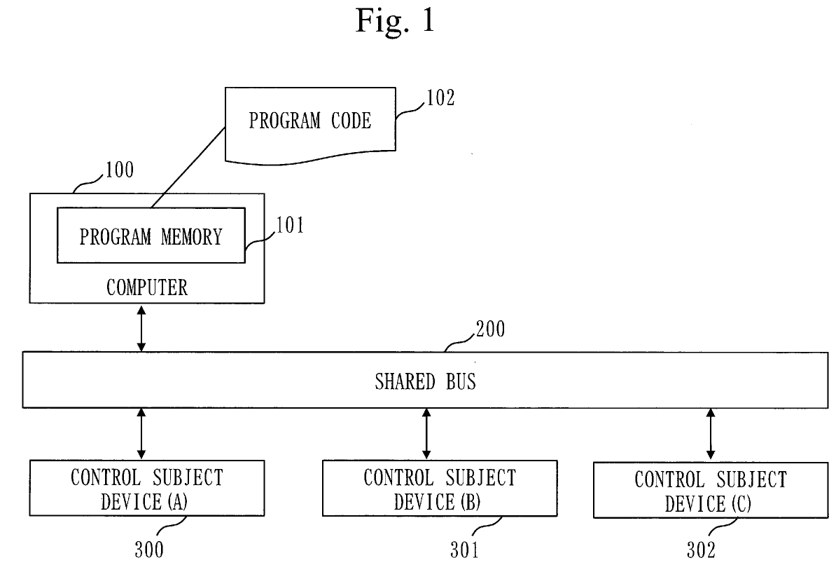

FIG. 1 illustrates a configuration example of the control system using one computer.

In FIG. 1, a computer 100 executes a program code 102 for controlling a control subject device (A) 300, a control subject device (B) 301, and a control subject device (C) 302. The computer 100 controls the control subject device (A) 300, the control subject device (B) 301, and the control subject device (C) 302 by executing the program code 102.

The computer 100 is connected to the control subject device (A) 300, the control subject device (B) 301, and the control subject device (C) 302 via a shared bus 200.

The computer 100 has a program memory 101. The program memory 101 stores the program code 102.

The computer 100 reads an operation state of each of the control subject device (A) 300, the control subject device (B) 301, and the control subject device (C) 302 via the shared bus 200. Further, the computer 100 generates a control signal for each of the control subject device (A) 300, the control subject device (B) 301, and the control subject device (C) 302 by using the operation state of each of the control subject device (A) 300, the control subject device (B) 301, and the control subject device (C) 302. Further, the computer 100 writes the control signal for each of the control subject device (A) 300, the control subject device (B) 301, and the control subject device (C) 302 into each of the control subject device (A) 300, the control subject device (B) 301, and the control subject device (C) 302 via the shared bus 200. By doing this, the computer 100 controls each of the control subject device (A) 300, the control subject device (B) 301, and the control subject device (C) 302.

Next, a control system using a plurality of computers will be described.

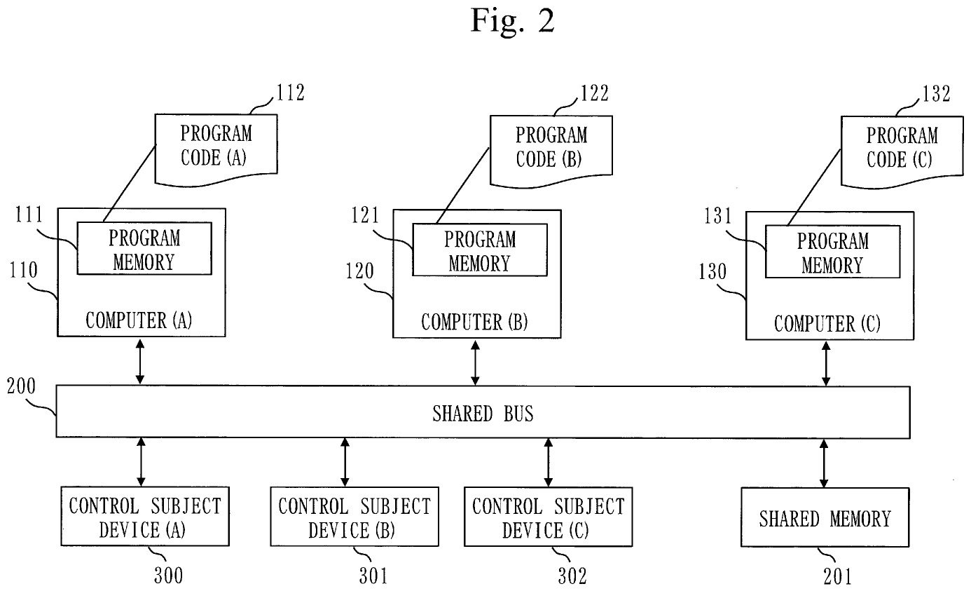

FIG. 2 illustrates a configuration example of the control system using three computers.

In FIG. 2, three computers (computer (A) 110, computer (B) 120, and computer (C) 130) are connected to the shared bus 200.

The program code 102 in FIG. 1 is divided into a program code (A) 112, a program code (B) 122, and a program code (C) 132. Then, the program code (A) 112 is placed in a program memory 111 of the computer (A) 110. Further, the program code (B) 122 is placed in a program memory 121 of the computer (B) 120. Further, the program code (C) 132 is placed in a program memory 131 of the computer (C) 130.

The computer (A) 110 controls the control subject device (A) 300, the control subject device (B) 301, and the control subject device (C) 302 via the shared bus 200 by executing the program code (A) 112. The computer (B) 120 controls the control subject device (A) 300, the control subject device (B) 301, and the control subject device (C) 302 via the shared bus 200 by executing the program code (B) 122. The computer (C) 130 controls the control subject device (A) 300, the control subject device (B) 301, and the control subject device (C) 302 via the shared bus 200 by executing the program code (C) 132.

When it is necessary to share data between the computer (A) 110, the computer (B) 120, and the computer (C) 130 in order to generate the control signal, the data is shared between the computer (A) 110, the computer (B) 120, and the computer (C) 130 by using a shared memory 201.

Generally, in the computer, there is a work area (work memory) for storing an interim computation result and the like required for executing the program code. The work area is constituted of a cache memory or a high-speed SRAM (Static Random Access Memory) so that high-speed access is possible.

On the other hand, since the shared memory 201 illustrated in FIG. 2 is accessed via the shared bus 200, the access speed is very slow. Therefore, data sharing between the computers using the shared memory 201 has a drawback in performance. Therefore, in order to make performance better than before division of the program code, it is necessary to consider reducing opportunities for accessing the shared memory 201 by the computer (A) 110, the computer (B) 120, and the computer (C) 130, which execute the program code after the division.

Further, in a control system in which a PLC is used as the computer, the same program code is repeatedly executed in a cycle which is called a scan time. The shorter the scan time is, the more detailed control instruction can be given to the control subject device. Therefore, the shorter the scan time is, the higher ability the control system has.

When the control subject devices are controlled using the plurality of computers, the scan time is regulated to an execution time of a computer with the slowest computation. Therefore, when the control subject devices are controlled using the plurality of computers, it is necessary to pay attention so that the execution time of the program code after the division in each computer is equal among the computers.

***Description of Configuration***

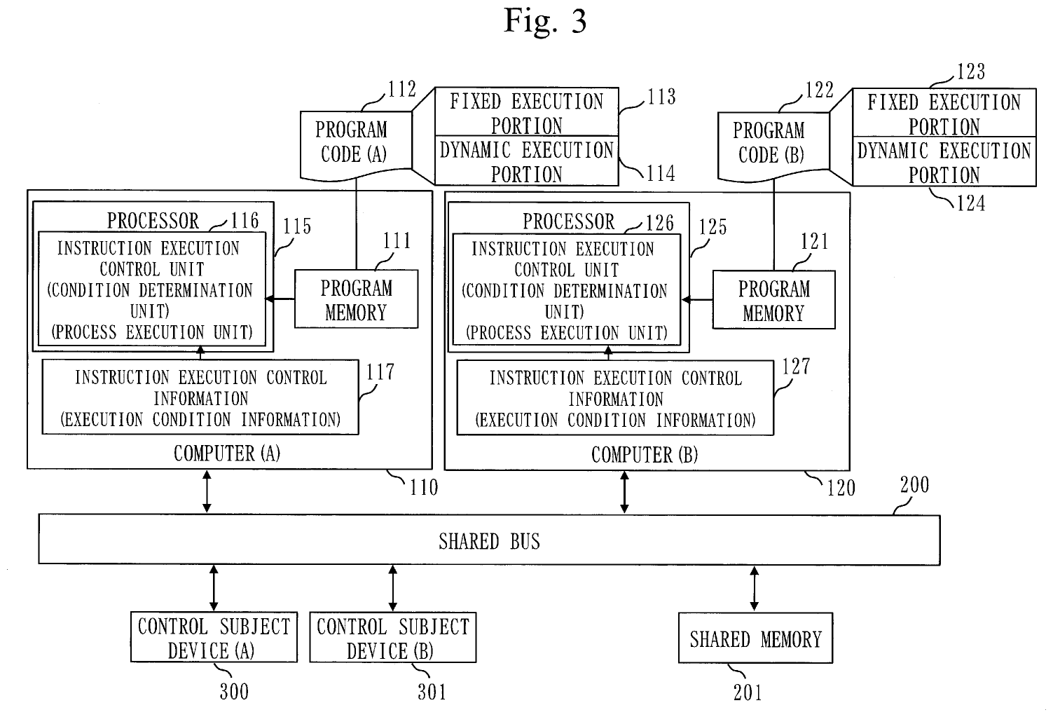

FIG. 3 illustrates a configuration example of the control system according to the present embodiment. In FIG. 3, for the reason of depiction, it is assumed that the control system according to the present embodiment is constituted of two computers which are the computer (A) 110 and the computer (B) 120. Further, it is assumed that the program code 102 is divided into the program code (A) 112 and the program code (B) 122. Further, it is assumed that the control subject device (A) 300 and the control subject device (B) 301 exist as the control subject devices.

Note that, the control system illustrated in FIG. 3 is an example of a computer system.

The computer (A) 110 includes the program memory 111, a processor 115, an instruction execution control unit 116, and instruction execution control information 117.

The computer (B) 120 includes the program memory 121, a processor 125, an instruction execution control unit 126, and instruction execution control information 127.

The program memory 111 stores the program code (A) 112. Further, the program memory 121 stores the program code (B) 122.

The program code (A) 112 is constituted of a fixed execution portion 113 and a dynamic execution portion 114.

The fixed execution portion 113 is a portion that is executed exclusively by the computer (A) 110. That is, the fixed execution portion 113 is executed only by the computer (A) 110.

The program code (B) 122 is also constituted of a fixed execution portion 123 and a dynamic execution portion 124. The fixed execution portion 123 is executed exclusively by the computer (B) 120. That is, the fixed execution portion 123 is executed only by the computer (B) 120.

The dynamic execution portion 114 and the dynamic execution portion 124 are the same process. Execution patterns of the dynamic execution portion 114 and the dynamic execution portion 124 vary depending on conditions. More specifically, depending on the success or failure of the conditions, (1) only the dynamic execution portion 114 may be executed by the computer (A) 110, (2) the dynamic execution portion 114 may be executed by the computer (A) 110, and the dynamic execution portion 124 may be executed by the computer (B) 120, and (3) only the dynamic execution portion 124 may be executed by the computer (B) 120. Which one of the dynamic execution portion 114 and the dynamic execution portion 124 is executed, is controlled according to the instruction execution control unit 116 and the instruction execution control information 117.

The instruction execution control information 117 defines a condition for executing the dynamic execution portion 114 by the computer (A) 110 and executing the dynamic execution portion 124 by the computer (B) 120, as an execution condition. Further, the instruction execution control information 117 indicates which portion of the dynamic execution portion 114 is executed by the computer (A) 110 when the execution condition is satisfied.

Similarly, the instruction execution control information 127 defines the execution condition, and indicates which portion of the dynamic execution portion 124 is executed by the computer (B) 120 when the execution condition is satisfied.

The process (dynamic execution portion 114 and dynamic execution portion 124) which is apportioned between and executed by the computer (A) 110 and the computer (B) 120 is also referred to as an apportioned execution process.

The execution condition is, for example, a condition related to a state of the control subject device (A) 300 or a state of the control subject device (B) 301, or a condition related to conditional branching such as an IF statement or a CASE statement.

The instruction execution control information 117 and the instruction execution control information 127 are generated so that an instruction amount (processing amount) executed by each computer becomes equal for each execution condition, by analyzing the program code 102 in advance.

Each of the instruction execution control information 117 and the instruction execution control information 127 is equivalent to execution condition information.

The instruction execution control unit 116 executes the program code (A) 112.

More specifically, the instruction execution control unit 116 executes the fixed execution portion 113 which is a process assigned uniquely to the computer (A) 110. Further, the instruction execution control unit 116 determines whether or not the execution condition is satisfied, with reference to the instruction execution control information 117. Then, if the execution condition is satisfied, the instruction execution control unit 116 executes the apportioned execution process with an apportionment with the computer (B) 120. The instruction execution control unit 116 is equivalent to a condition determination unit and a process execution unit.

Specifically, the instruction execution control unit 116 is a program executed by the processor 115.

Similarly, the instruction execution control unit 126 executes the program code (B) 122.

More specifically, the instruction execution control unit 126 executes the fixed execution portion 123 which is a process assigned uniquely to the computer (B) 120. Further, the instruction execution control unit 126 determines whether or not the execution condition is satisfied, with reference to the instruction execution control information 127. Then, if the execution condition is satisfied, the instruction execution control unit 126 executes the apportioned execution process with an apportionment with the computer (A) 110. The instruction execution control unit 126 is also equivalent to the condition determination unit and the process execution unit.

Specifically, the instruction execution control unit 126 is also a program executed by the processor 125.

Next, a program code assignment apparatus 500 will be described. The program code assignment apparatus 500 divides the program code 102 into the program code (A) 112 and the program code (B) 122, and also generates the instruction execution control information 117 and the instruction execution control information 127.

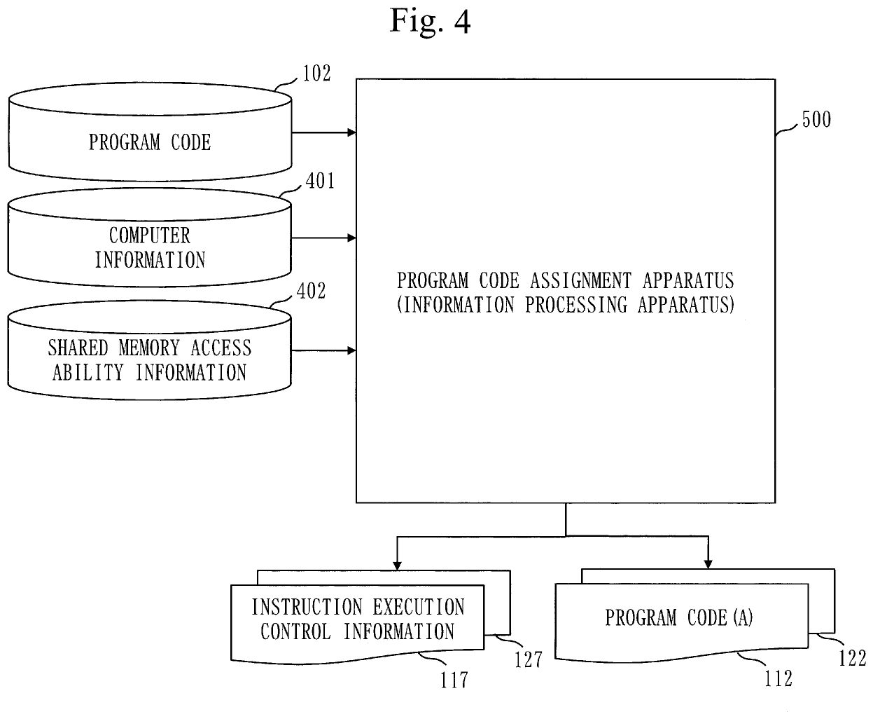

FIG. 4 illustrates the program code assignment apparatus 500. The program code assignment apparatus 500 is a computer.

Further, the program code assignment apparatus 500 is an example of an information processing apparatus. Further, operation performed by the program code assignment apparatus 500 is equivalent to an information processing method and an information processing program.

The program code assignment apparatus 500 divides the program code 102 into the program code (A) 112 and the program code (B) 122 with reference to the program code 102, computer information 401, and shared memory access ability information 402. Further, the program code assignment apparatus 500 generates the instruction execution control information 117 and the instruction execution control information 127.

The computer information 401 indicates the number of computers included in the control system. In the following, it is assumed that the computer information 401 indicates that the control system includes two computers which are the computer (A) 110 and the computer (B) 120 as illustrated in FIG. 3. Further, the computer information 401 indicates ability of the computer (A) 110 and ability of the computer (B) 120.

The shared memory access ability information 402 indicates access ability (access delay) when the computer (A) 110 and the computer (B) 120 access the shared memory 201.

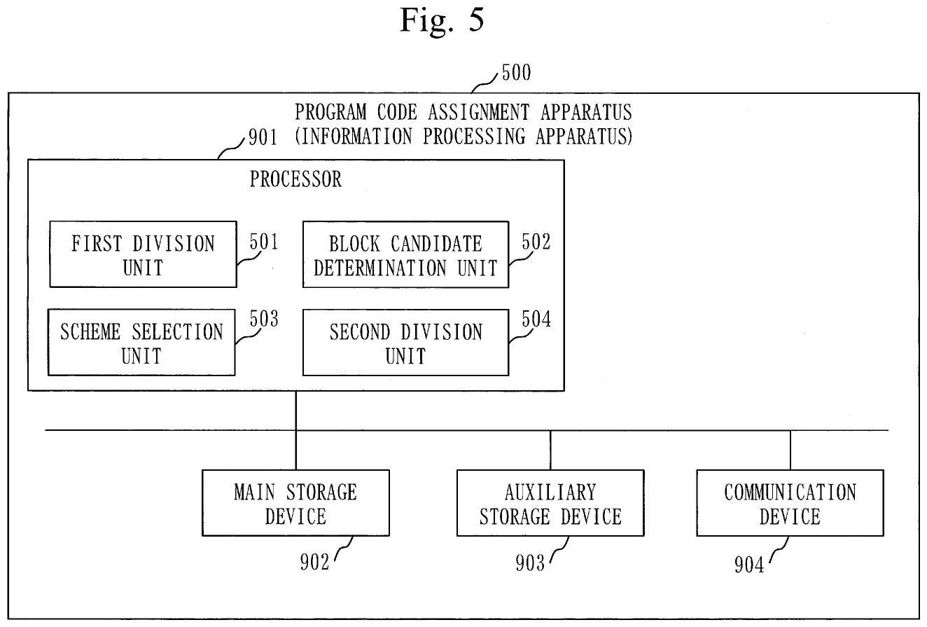

FIG. 5 illustrates a hardware configuration example of the program code assignment apparatus 500.

The program code assignment apparatus 500 includes a processor 901, a main storage device 902, an auxiliary storage device 903, and a communication device 904 as pieces of hardware.

The processor 901 is an IC (Integrated Circuit) that performs processing.

The processor 901 is a CPU (Central Processing Unit), a DSP (Digital Signal Processor), or the like.

The main storage device 902 is a RAM (Random Access Memory).

The auxiliary storage device 903 is a ROM (Read Only Memory), a flash memory, an HDD (Hard Disk Drive), or the like.

The communication device 904 is an electronic circuit that executes a communication process of data.

The communication device 904 is, for example, a communication chip or an NIC (Network Interface Card).

The auxiliary storage device 903 stores programs that realize functions of a first division unit 501, a block candidate determination unit 502, a scheme selection unit 503, and a second division unit 504 which will be described later.

These programs are loaded from the auxiliary storage device 903 into the main storage device 902. Then, the processor 901 executes these programs and operates the first division unit 501, the block candidate determination unit 502, the scheme selection unit 503, and the second division unit 504.

FIG. 5 schematically illustrates a state where the processor 901 executes the programs that realize the functions of the first division unit 501, the block candidate determination unit 502, the scheme selection unit 503, and the second division unit 504.

An OS (Operating System) is also stored in the auxiliary storage device 903.

Then, at least a part of the OS is executed by the processor 901.

While executing at least the part of the OS, the processor 901 executes the programs that realize the functions of the first division unit 501, the block candidate determination unit 502, the scheme selection unit 503, and the second division unit 504.

By the processor 901 executing the OS, task management, memory management, file management, communication control, and the like are performed.

Further, at least one of information, data, a signal value, and a variable value indicating a processing result of the first division unit 501, the block candidate determination unit 502, the scheme selection unit 503, and the second division unit 504 is stored in at least one of the main storage device 902, the auxiliary storage device 903, and a register and a cache memory in the processor 901.

The programs that realize the functions of the first division unit 501, the block candidate determination unit 502, the scheme selection unit 503, and the second division unit 504 may be stored in a portable recording medium such as a magnetic disk, a flexible disk, an optical disk, a compact disk, a Blu-ray (registered trademark) disk, a DVD, or the like. Then, the portable recording medium storing the programs that realize the functions of the first division unit 501, the block candidate determination unit 502, the scheme selection unit 503, and the second division unit 504 may be commercially distributed.

Further, “unit” of the first division unit 501, the block candidate determination unit 502, the scheme selection unit 503, and the second division unit 504 may be read as “circuit” or “step” or “procedure” or “process”.

Further, the program code assignment apparatus 500 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

In this case, each of the first division unit 501, the block candidate determination unit 502, the scheme selection unit 503, and the second division unit 504 is realized as a part of the processing circuit.

Note that, in the present specification, a superordinate concept of the processor and the processing circuit is referred to as “processing circuitry”.

That is, each of the processor and the processing circuit is a specific example of the “processing circuitry”.

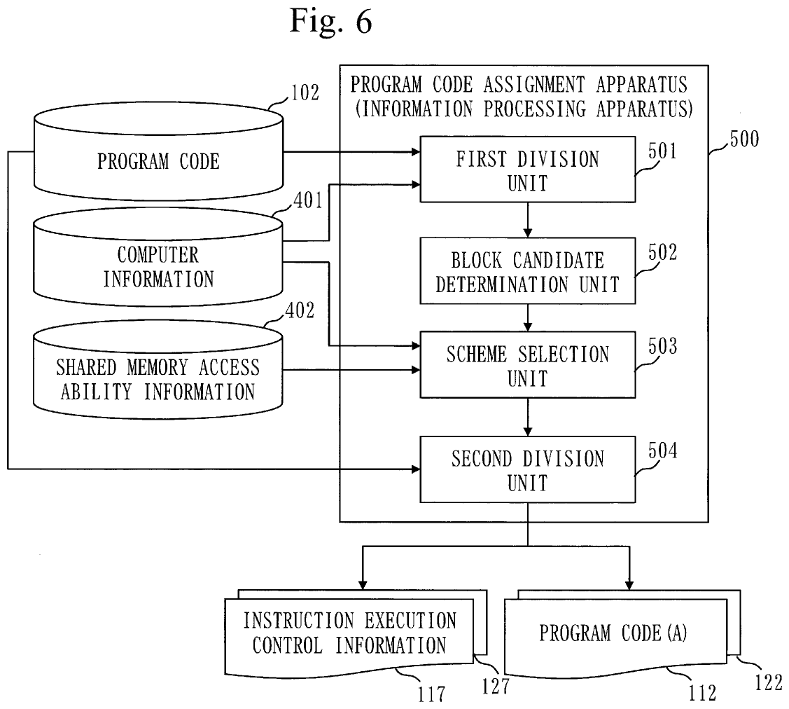

FIG. 6 illustrates a functional configuration example of the program code assignment apparatus 500.

The first division unit 501 divides the program code 102 into a plurality of block candidates, while permitting a part of processes in the program code 102 to coexist in two or more block candidates.

Note that, a process performed by the first division unit 501 is equivalent to a first division process.

The block candidate determination unit 502 determines whether or not the part of the processes in the program code 102 coexists in the two or more block candidates among the plurality of block candidates. The part of the processes in the program code 102 coexisting in the two or more block candidates is referred to as a coexistence process.

Further, the block candidate determination unit 502 determines whether or not the program code 102 includes a load variation process which is a process whose execution time varies depending on a condition. Specifically, the load variation process is a process (apportioned execution process) described in the dynamic execution portion 114.

Note that, a process performed by the block candidate determination unit 502 is equivalent to a block candidate determination process.

The scheme selection unit 503 selects one of a parallel execution scheme and a shared execution scheme when the part of the processes in the program code 102 coexists in the two or more block candidates.

The parallel execution scheme is a scheme causing two or more computers, which are the same number as the two or more block candidates, to execute in parallel, the coexistence process which is the part of the processes in the program code 102 coexisting in the two or more block candidates.

The shared execution scheme is a scheme causing one computer among the two or more computers to execute the coexistence process and causing the other computer among the two or more computers to share an execution result of the one computer.

Further, the scheme selection unit 503 selects one of a single execution scheme and the apportioned execution scheme when the load variation process is included in the program code 102.

The single execution scheme is a scheme causing the one computer among the plurality of computers to execute the load variation process.

The apportioned execution scheme is a scheme causing the plurality of computers to execute the load variation process with an apportionment among the plurality of computers.

A process performed by the scheme selection unit 503 is equivalent to a scheme selection process.

The second division unit 504 divides the program code 102 into a plurality of blocks based on the plurality of block candidates and the scheme which is selected by the scheme selection unit 503. Then, the second division unit 504 outputs as the program code (A) 112 and the program code (B) 122, each block obtained by the division.

Further, the second division unit 504 generates the instruction execution control information 117 and the instruction execution control information 127, and outputs the instruction execution control information 117 and the instruction execution control information 127 which are generated.

***Description of Operation***

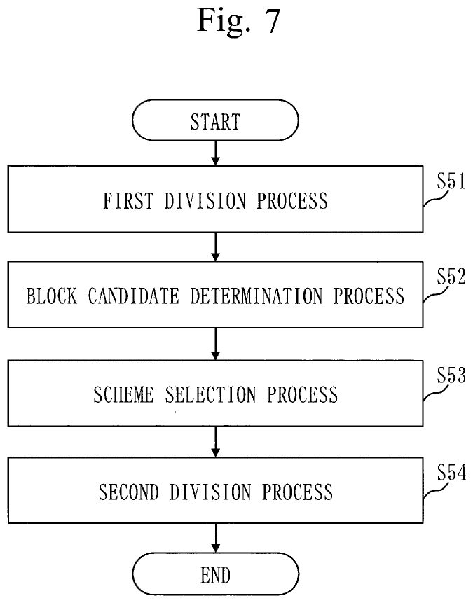

FIG. 7 is a flowchart illustrating an outline of operation of the program code assignment apparatus 500.

The outline of the operation of the program code assignment apparatus 500 will be described with reference to FIG. 7.

In step S51, the first division unit 501 divides the program code 102 into the plurality of block candidates.

By referring to the computer information 401, the first division unit 501 recognizes that the computer (A) 110 and the computer (B) 120 exist in the control system according to the present embodiment. For this reason, in the present embodiment, the first division unit 501 divides the program code 102 into two block candidates.

Further, the first division unit 501 analyzes the program code 102 and specifies a plurality of processes constituting the program code 102. Further, the first division unit 501 specifies an execution order of the processes constituting the program code 102. Then, the first division unit 501 divides the program code 102 into the two block candidates based on the execution order. Note that, when there exist a plurality of patterns each of which divides the program code 102 into the two block candidates, the first division unit 501 selects a pattern with the shortest execution time of the program code 102 among the plurality of patterns. Then, the first division unit 501 divides the program code 102 into the two block candidates according to the selected pattern.

Note that, the first division unit 501 does not need to actually divide the program code 102 into the two block candidates, and it is sufficient if the program code 102 is logically divided into the two block candidates.

Next, in step S52, the block candidate determination unit 502 determines whether or not the coexistence process exists in the program code 102. Further, the block candidate determination unit 502 determines whether or not the load variation process exists in the program code 102.

Next, in step S53, the scheme selection unit 503 selects the scheme.

When it is determined in step S52 that the coexistence process exists in the program code 102, the scheme selection unit 503 selects one of the parallel execution scheme and the shared execution scheme as a division scheme of the program code 102. More specifically, the scheme selection unit 503 compares an execution time to be taken when the program code 102 is executed in the parallel execution scheme with an execution time to be taken when the program code 102 is executed in the shared execution scheme. Then, the scheme selection unit 503 selects a scheme with shorter execution time between the parallel execution scheme and the shared execution scheme.

Further, when it is determined in step S52 that the load variation process exists in the program code 102, the scheme selection unit 503 selects one of the single execution scheme and the shared execution scheme as the division scheme of the program code 102. More specifically, the scheme selection unit 503 compares for each condition, an execution time to be taken when the program code 102 is executed in the single execution scheme with the execution time to be taken when the program code 102 is executed in the apportioned execution scheme. Then, the scheme selection unit 503 selects for each condition, a scheme with shorter execution time between the single execution scheme and the apportioned execution scheme.

Next, in step S54, the second division unit 504 divides the program code 102 into the two blocks.

More specifically, when the parallel execution scheme is selected by the scheme selection unit 503 in step S53, the second division unit 504 divides the program code 102 into the two blocks based on the two block candidates so that the coexistence process is executed by the computer (A) 110 and the computer (B) 120 in parallel.

When the shared execution scheme is selected by the scheme selection unit 503 in step S53, the second division unit 504 divides the program code 102 into the two blocks based on the two block candidates so that the coexistence process is executed only by the computer (A) 110 or the computer (B) 120.

Further, when the single execution scheme is selected by the scheme selection unit 503 in step S53, the second division unit 504 divides the program code 102 into the two blocks based on the two block candidates so that the load variation process is executed only by the computer (A) 110 or the computer (B) 120.

Further, when the apportioned execution scheme is selected by the scheme selection unit 503 in step S53, the second division unit 504 divides the program code 102 into the two blocks based on the two block candidates so that the load variation process is apportioned between and executed by the computer (A) 110 and the computer (B) 120. Further, the second division unit 504 generates the instruction execution control information 117 and the instruction execution control information 127.

Then, the second division unit 504 outputs the two blocks as the program code (A) 112 and the program code (B) 122, and also outputs the instruction execution control information 117 and the instruction execution control information 127.

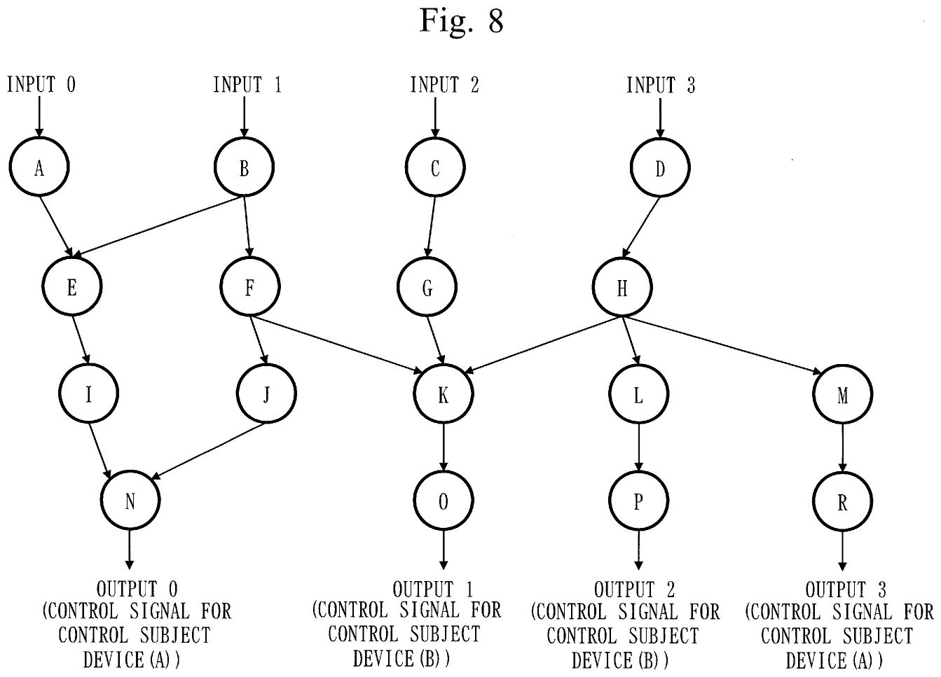

FIG. 8 illustrates an example of program execution order information 403 according to the present embodiment. In the program execution order information 403, the processes included in the program code 102 and the execution order of the processes are indicated in a data flow graph (DFG) format. The first division unit 501 can recognize a configuration illustrated in FIG. 8 by analyzing the program code 102.

The first division unit 501 can logically divide the program code 102 into the two block candidates by dividing the configuration illustrated in FIG. 8 into two portions.

In FIG. 8, “A” to “R” represent processes required for generating the control signals for the control subject device (A) 300 and the control subject device (B) 301.

The first division unit 501 divides the instruction amount (processing amount) of each process in the program code 102 by each of processing ability of the computer (A) 110 and processing ability of the computer (B) 120 indicated in the computer information 401. By doing so, the first division unit 501 can obtain the execution time of each process by the computer (A) 110 and the execution time of each process by the computer (B) 120. Note that, here, for simplicity of descriptions, it is assumed that the execution time of all the processes is the same in the computer (A) 110 and the computer (B) 120, and is uniformly 1T.

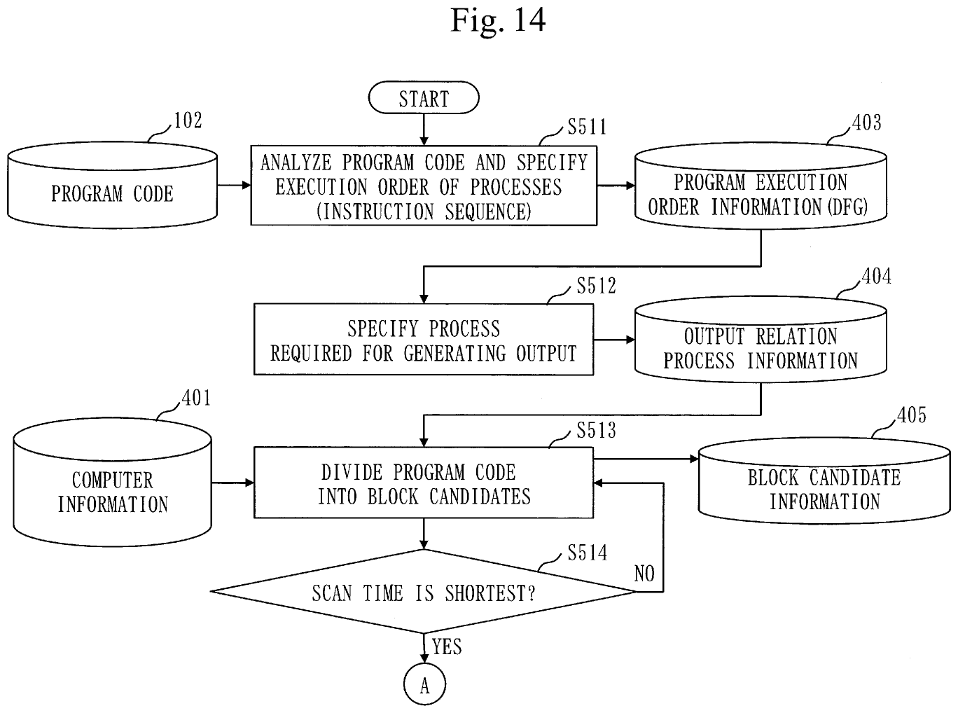

An operation example of the first division unit 501 will be described with reference to FIG. 8 and FIG. 14.

FIG. 14 is a flowchart illustrating details of step S51 illustrated in FIG. 4.

In step S511, the first division unit 501 analyzes the program code 102 and extracts the processes included in the program code 102. Further, the first division unit 501 specifies the execution order of the processes.

As a result of step S511, the program execution order information 403 exemplified in FIG. 8 is obtained.

Next, in step S512, the first division unit 501 specifies the process required for generating output 0 to output 3 illustrated in FIG. 8. In an example in FIG. 8, processes required for generating the output 0 are (A, B, E, F, I, J, N). Further, processes required for generating the output 1 are (B, C, D, F, G, H, K, O). Processes required for generating the output 2 are (D, H, L, P). Further, processes required for generating the output 3 are (D, H, M, R).

As a result of step S512, output relation process information 404 is obtained.

The output relation process information 404 indicates a set of the output and the processes required for generating the output.

Next, in step S513, the first division unit 501 divides the program code 102 into the block candidates.

In the present embodiment, the first division unit 501 divides the program code 102 into the two block candidates.

That is, the first division unit 501 assigns the processes required for generating the output 0 to one of the computer (A) 110 and the computer (B) 120. Further, the first division unit 501 assigns the processes required for generating the output 1 to one of the computer (A) 110 and the computer (B) 120. Further, the first division unit 501 assigns the processes required for generating the output 2 to one of the computer (A) 110 and the computer (B) 120. Further, the first division unit 501 assigns the processes required for generating the output 3 to one of the computer (A) 110 and the computer (B) 120.

Further, as described in step S514, when there are a plurality of patterns each of which divides the program code 102 into the block candidates, the first division unit 501 selects a pattern with the shortest execution time (scan time) of the program code 102 among the plurality of patterns.

The first division unit 501 can obtain the execution time (scan time) of each process in the program code 102 by referring to the computer information 401. Note that, in the present embodiment, as described above, for simplicity of descriptions, it is assumed that the execution time of each process is uniformly 1T.

When the pattern with the shortest execution time (scan time) is found, the first division unit 501 generates block candidate information 405 indicating the block candidates in the pattern. Then, the first division unit 501 outputs the block candidate information 405 to the block candidate determination unit 502.

Note that, the first division unit 501 may select a pattern whose execution time (scan time) is equal to or shorter than a threshold value, instead of selecting the pattern with the shortest execution time (scan time).

In the example in FIG. 8, there are 2\hat{ }4=16 combinations for assigning processes (4 patterns) required for generating the output 0 to the output 3 to the computer (A) 110 and the computer (B) 120.

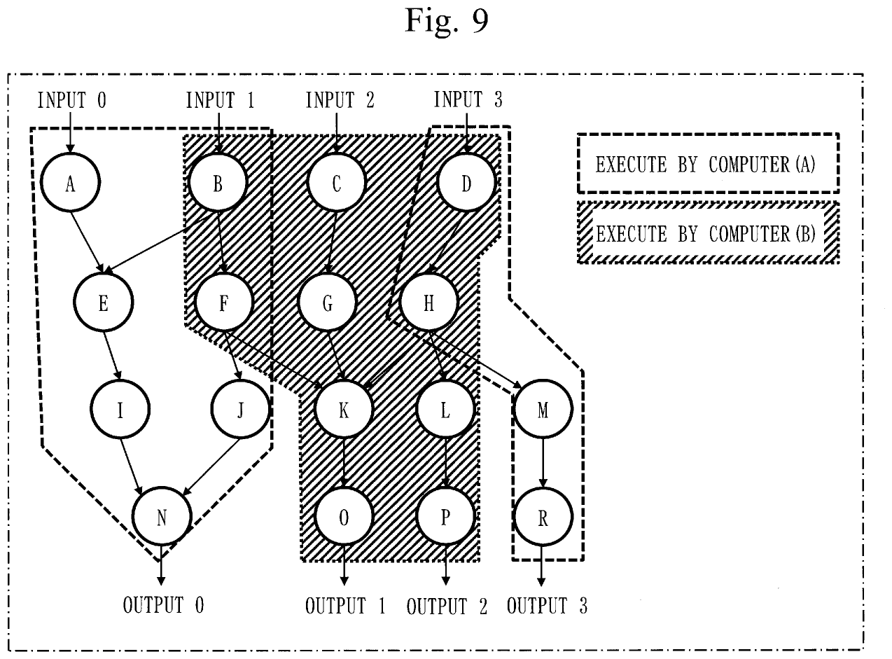

FIG. 9 illustrates the pattern with the shortest execution time among the 16 patterns. That is, FIG. 9 illustrates an example of the block candidate information 405.

In an example in FIG. 9, the computer (A) 110 executes processes (A, B, E, F, I, J, N and D, H, M, R). Further, the computer (B) 120 executes the processes (B, C, D, F, G, H, K, L, O, P).

In the example in FIG. 9, the execution time of the computer (A) 110 is 11T. On the other hand, the execution time of the computer (B) 120 is 10T. The scan time is regulated to longer one between the execution time of the computer (A) 110 and the execution time of the computer (B) 120. For this reason, in the example in FIG. 9, the execution time (=scan time) of the whole program code 102 is 11T.

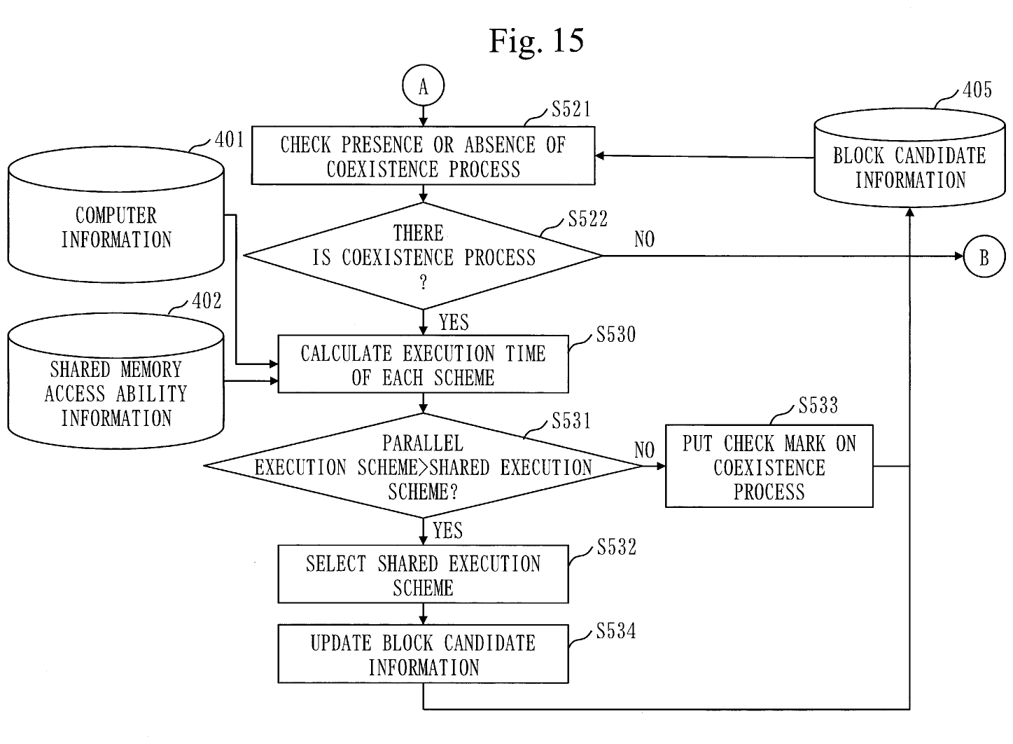

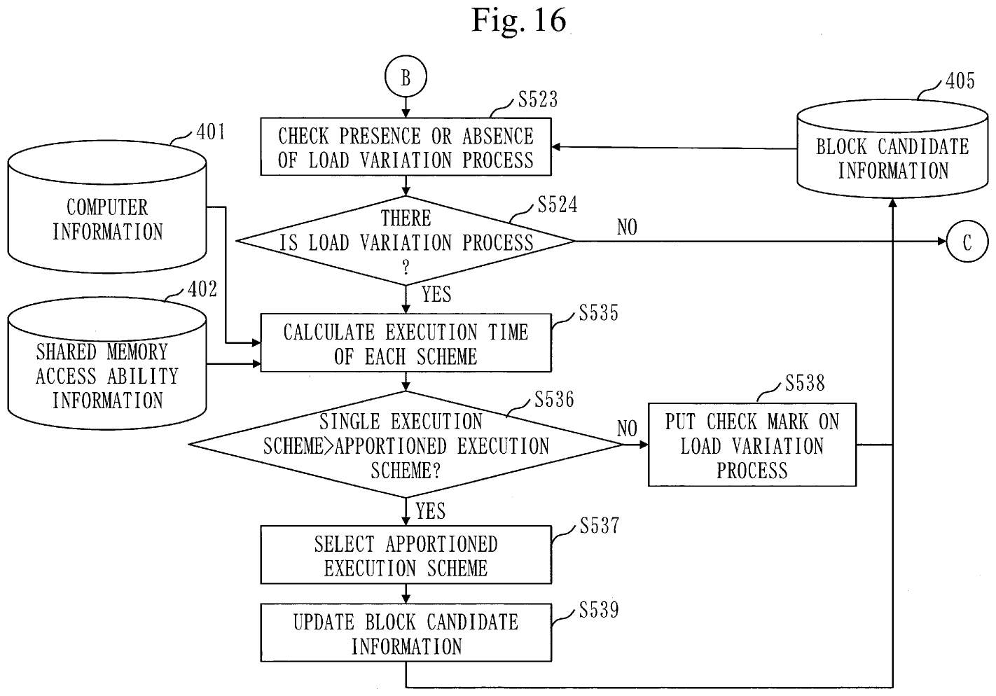

Next, operation examples of the block candidate determination unit 502 and the scheme selection unit 503 will be described with reference to FIGS. 15 and 16.

FIGS. 15 and 16 are flowcharts illustrating details of step S52 and step S53 illustrated in FIG. 4. Steps S52X are the details of step S52. Steps S53X are the details of step S53.

When the block candidate determination unit 502 acquires the block candidate information 405, the block candidate determination unit 502 analyzes the block candidate information 405, and in step S521, checks presence or absence of the coexistence process.

When the coexistence process exists (YES in step S522), the process proceeds to step S530. Note that, in this case, the block candidate determination unit 502 notifies the scheme selection unit 503 of the coexistence process.

On the other hand, if the coexistence process does not exist (NO in step S522), the process proceeds to step S523 in FIG. 16.

In step S530, the scheme selection unit 503 calculates the execution time of each scheme.

That is, the scheme selection unit 503 calculates the execution time of the parallel execution scheme and the execution time of the shared execution scheme.

Then, in step S531, the scheme selection unit 503 determines whether or not the execution time of the parallel execution scheme is longer than the execution time of the shared execution scheme.

When the execution time of the parallel execution scheme is longer than the execution time of the shared execution scheme (YES in step S531), that is, when the execution time of the shared execution scheme is equal to or shorter than the execution time of the parallel execution scheme, the scheme selection unit 503 selects the shared execution scheme in step S532.

On the other hand, when the execution time of the parallel execution scheme is equal to or shorter than the execution time of the shared execution scheme (NO in step S531), in step S533, the scheme selection unit 503 puts a check mark on the coexistence process currently being focused on. The coexistence process with the check mark put on is not subject to subsequent step S521.

In step S534, the scheme selection unit 503 updates the block candidate information 405 according to the shared execution scheme.

A process of step S521 and processes after step S521 are repeated until a process of step S530 and processes after step S530 are performed for all the coexistence processes.

In the example in FIG. 9, the process (B), the process (F), the process (D), and the process (H) coexist in the block candidate of the computer (A) 110 and the block candidate of the computer (B) 120, and are the coexistence processes.

A result of the process (B) is used in the process (F) and the process (E) (executed by the computer (A) 110).

A result of the process (F) is used in the process (J) (executed by the computer (A) 110) and the process (K) (executed by the computer (B) 120).

A result of the process (D) is used in the process (H).

Further, a result of the process (H) is used in the process (M) (executed by the computer (A) 110), and the process (K) and the process (L) (both executed by the computer (B) 120).

Since the result of the process (B) is used in the process (F), it is desirable that the process (B) and the process (F) are extracted by the same computer.

Here, as the shared execution scheme, for example, it is assumed that the process (B) and the process (F) are executed only by the computer (B) 120, and the computer (A) 110 shares the result of the process (F). In this case, the computer (A) 110 does not have to execute the processes taking 2T. Therefore, the execution time of the computer (A) 110 may become shorter than 11T.

However, as described above, the sharing of the information between the computers needs to be via the shared memory 201. Using the shared memory 201 causes an overhead. Therefore, it is necessary to take the overhead into consideration as to whether or not the process (B) and the process (F) are assigned to the computer (B) 120.

In the present embodiment, the overhead is an access time from the computer (A) 110 and the computer (B) 120 to the shared memory 201. The access time to the shared memory 201 depends on an amount of data to be shared. The overhead is assumed to be a function (O(x)) of a data amount x of a process X. That is, the overhead caused when sharing the result of the process (F) using the shared memory 201, is O(f).

Based on whether or not longer one between the time required for the processes (A, E, I, J, N and D, H, M, R, and O(f)) of the computer (A) 110 and the time required for the processes (B, C, D, F, G, H, K, L, O, P) of the computer (B) 120 is longer than the scan time (11T) when the sharing is not taken into consideration (when the shared memory 201 is not used), it is possible to determine whether or not the process (B) and the process (F) are executed only by the computer (B) 120. That is, when the longer one between the time required for the processes (A, E, I, J, N and D, H, M, R, and O(f)) of the computer (A) 110 and the time required for the processes (B, C, D, F, G, H, K, L, O, P) of the computer (B) 120 is shorter than the scan time (11T) when the sharing is not taken into consideration (when the shared memory 201 is not used), the scan time can be shortened. Therefore, in this case, it is desirable that only the computer (B) 120 executes the process (B) and the process (F) (shared execution scheme). If the longer one between the time required for the processes (A, E, I, J, N, and D, H, M, R, and O(f)) of the computer (A) 110 and the time required for the processes (B, C, D, F, G, H, K, L, O, P) of the computer (B) 120 is equal to or longer than the scan time (11T) when the sharing is not taken into consideration (when the shared memory 201 is not used), the scan time does not change or the scan time increases. Therefore, it is desirable that each of the computer (A) 110 and the computer (B) 120 executes the process (B) and the process (F) (parallel execution scheme).

In order to simplify the descriptions, here, it is assumed that O(f)=1T.

When the process (B) and the process (F) are executed only by the computer (B) 120, and the execution result of the process (F) is shared using the shared memory 201, the time required for executing all the processes of the computer (A) 110 is 10T. Therefore, the execution time of the computer (A) 110 when the computer (A) 110 does not execute the process (B) and the process (F) is shorter than the scan time (11T) when the computer (A) 110 executes the process (B) and the process (F). In this case, it can be determined that it is better to execute the process (B) and the process (F) only by the computer (B) 120.

Similarly, also the process (D) and the process (H) will be considered.

When only the computer (A) 110 executes the process (D) and the process (H), the execution time of the computer (A) 110 is 10T, and the execution time of the computer (B) 120 is 9T.

When only the computer (B) 120 executes the process (D) and the process (H), the execution time of the computer (A) 110 is 9T, and the execution time of the computer (B) 120 is 10T. Since the longer execution time is 10T in both cases, both scan times are 10T. Therefore, either a case where only the computer (A) 110 executes the process (D) and the process (H) or a case where only the computer (B) 120 executes the process (D) and the process (H) may be selected.

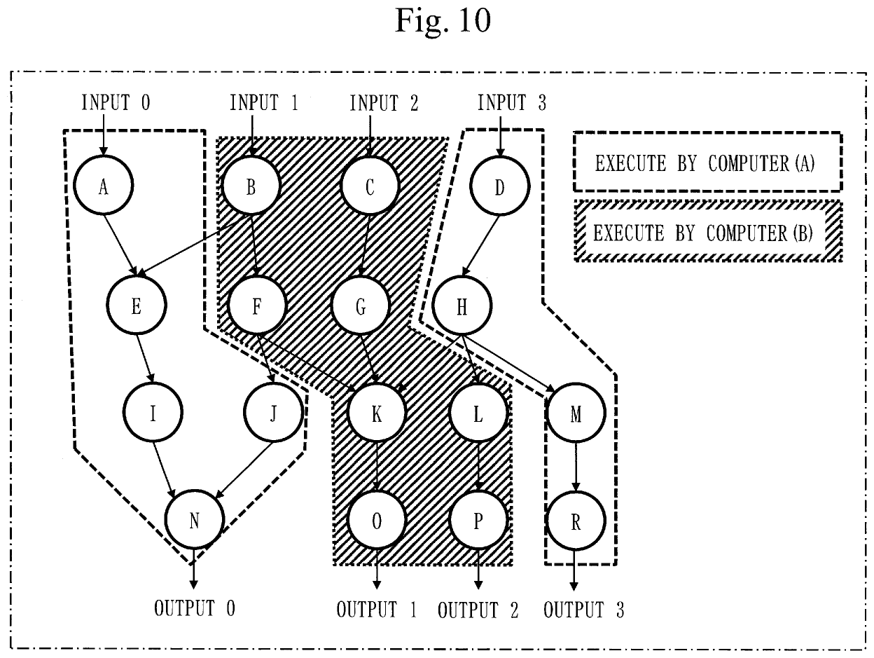

FIG. 10 illustrates, as an example, an example of block candidates employed when the process (B) and the process (F) are executed only by the computer (B) 120, and the process (D) and the process (H) are executed only by the computer (A) 110.

Next, a process of step S523 and processes after step S523 in FIG. 16 will be described.

In step S523, the block candidate determination unit 502 checks the presence or absence of the load variation process with reference to the block candidate information 405.

If there is the load variation process (YES in step S524), the process proceeds to step S535. Note that, in this case, the block candidate determination unit 502 notifies the scheme selection unit 503 of the load variation process.

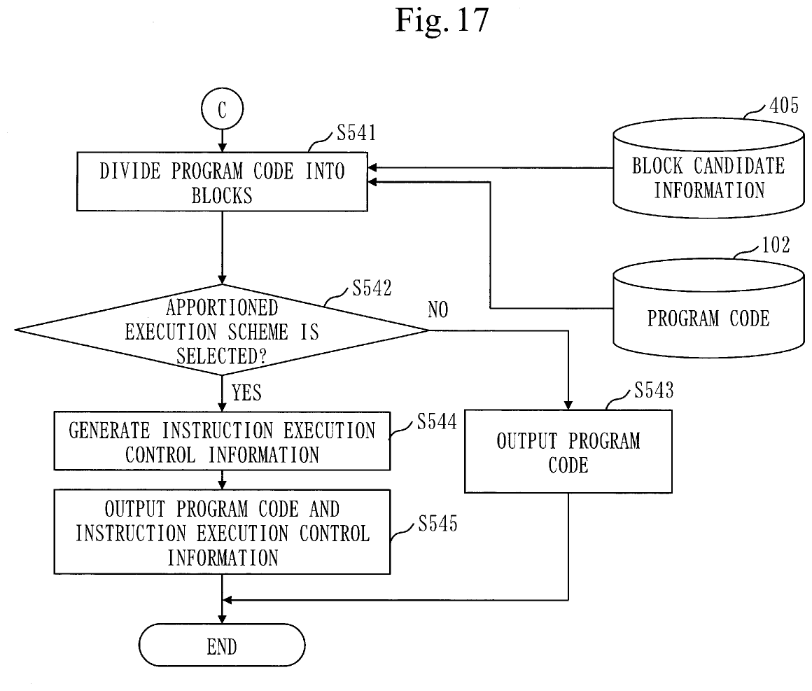

On the other hand, if the load variation process does not exist (NO in step S524), the process proceeds to step S541 in FIG. 17.

In step S535, the scheme selection unit 503 calculates the execution time of each scheme.

That is, the scheme selection unit 503 calculates the execution time of the single execution scheme and the execution time of the apportioned execution scheme.

Then, in step S536, the scheme selection unit 503 determines whether or not the execution time of the single execution scheme is longer than the execution time of the apportioned execution scheme.

When the execution time of the single execution scheme is longer than the execution time of the apportioned execution scheme (YES in step S536), that is, when the execution time of the apportioned execution scheme is equal to or shorter than the execution time of the single execution scheme, in step S537, the scheme selection unit 503 selects the apportioned execution scheme.

On the other hand, when the execution time of the single execution scheme is equal to or shorter than the execution time of the apportioned execution scheme (NO in step S536), in step S538, the scheme selection unit 503 puts the check mark on the load variation process currently being focused on. The load variation process with the check mark put on is not subject to subsequent step S523.

In step S539, the scheme selection unit 503 updates the block candidate information 405 according to the apportioned execution scheme.

Further, in this case, the scheme selection unit 503 notifies the second division unit 504 that the apportioned execution scheme is selected, and notifies the second division unit 504 of the load variation process for which the apportioned execution scheme is selected.

The process of step S523 and the processes after step S523 are repeated until the process of step S535 and the processes after step S535 are performed for all the load variation processes.

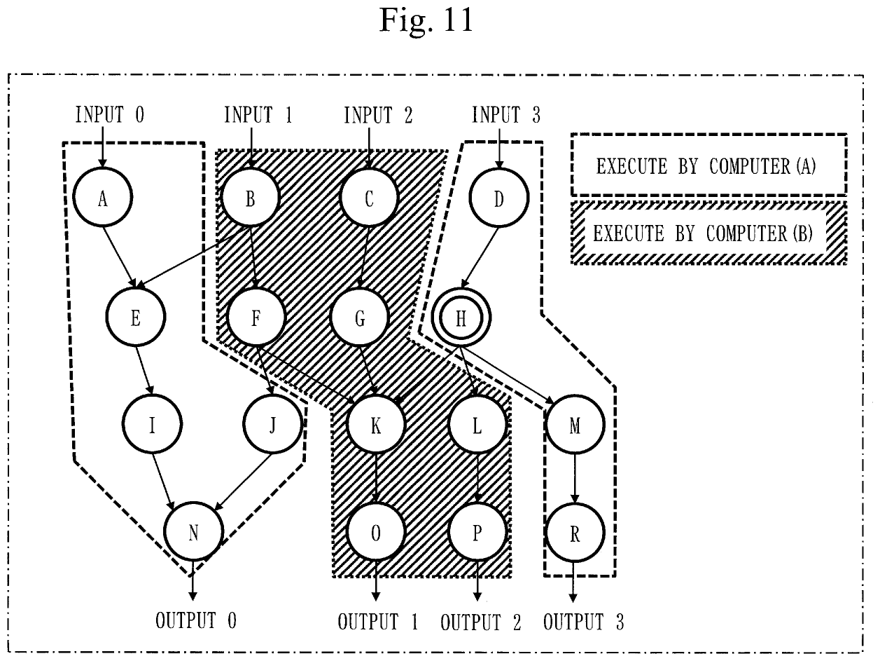

FIG. 11 illustrates an example of the program code 102 in which the load variation process exists.

In FIG. 11, the process (H) is the load variation process.

In an example in FIG. 11, it is assumed that the processing amount of the process (H) changes depending on the result of the process (D). Specifically, when the result of the process (D) meets a criterion a, that is, when a condition that the result of the process (D) meets the criterion a is satisfied, it is assumed that the execution time of the process (H) changes to 2T. On the other hand, when the result of the process (D) does not meet the criterion a, that is, when the condition that the result of the process (D) meets the criterion a is unsatisfied, it is assumed that the execution time of the process (H) is still 1T.

In such a case, the scheme selection unit 503 determines whether the process (H) is apportioned between the computer (A) 110 and the computer (B) 120 (selecting the apportioned execution scheme), or the process (H) is executed by the computer (A) 110 alone (selecting the single execution scheme).

The execution time of the computer (A) 110 and the execution time of the computer (B) 120 when the process (H) is executed only by the computer (A) 110 (single execution scheme) are as follows.

(1) When the result of the process (D) meets the criterion a

$$( 1 ) When the result of the process ( D ) meets the criterion α$$

$$Execution time of computer ( A ) 110 = Processes ( A , E , I , J , N , O ( f ) ) + Processes ( D , {2}^{*} H , M , R ) = 6 T + 5 T = 11 T$$

$$Execution time of computer ( B ) 120 = Processes ( B , C , F , G , K , L , O , P + O ( h ) ) = 9 T \\ ( 2 ) When the result of the process ( D ) does not meet the criterion α$$

$$Execution time of computer ( A ) 110 = Processes ( A , E , I , J , N , O ( f ) ) + Processes ( D , H , M , R ) = 6 T + 4 T = 10 T \\ Execution time of computer ( B ) 120 = Processes ( B , C , F , G , K , L , O , P + O ( h ) ) = 9 T$$

Next, in a case where the process (H) is assigned to the computer (A) 110 and the computer (B) 120, where the result of the process (D) meets the criterion a, and where the computer (A) 110 and the computer (B) 120 each execute the process (H) for 1T (apportioned execution scheme) when the execution time increases, the execution time of the computer (A) 110 and the execution time of the computer (B) 120 are as follows.
(1) When the result of the process (D) meets the criterion a

$$Execution time of computer ( A ) 110 = Processes ( A , E , I , J , N , O ( f ) ) + Processes ( D , H , M , R ) = 6 T + 4 T = 10 T$$

$$Execution time of computer ( B ) 120 = Processes ( B , C , F , G , K , L , O , P + H ) = 9 T$$

(2) When the result of the process (D) does not meet the criterion a

$$Execution time of computer ( A ) 110 = Processes ( A , E , I , J , N , O ( f ) ) + Processes ( D , H , M , R ) = 6 T + 4 T = 10 T$$

$$Execution time of computer ( B ) 120 = Processes ( B , C , F , G , K , L , O , P + H ) = 9 T$$

In the above example, the execution time (10T) of the computer (A) 110 in the apportioned execution scheme to be taken when the result of the process (D) meets the criterion a is shorter than the execution time (11T) of the computer (A) 110 in the single execution scheme to be taken when the result of the process (D) meets the criterion a. Therefore, in the above example, since the scan time can be shortened if the apportioned execution scheme is selected, the scheme selection unit 503 selects the apportioned execution scheme.

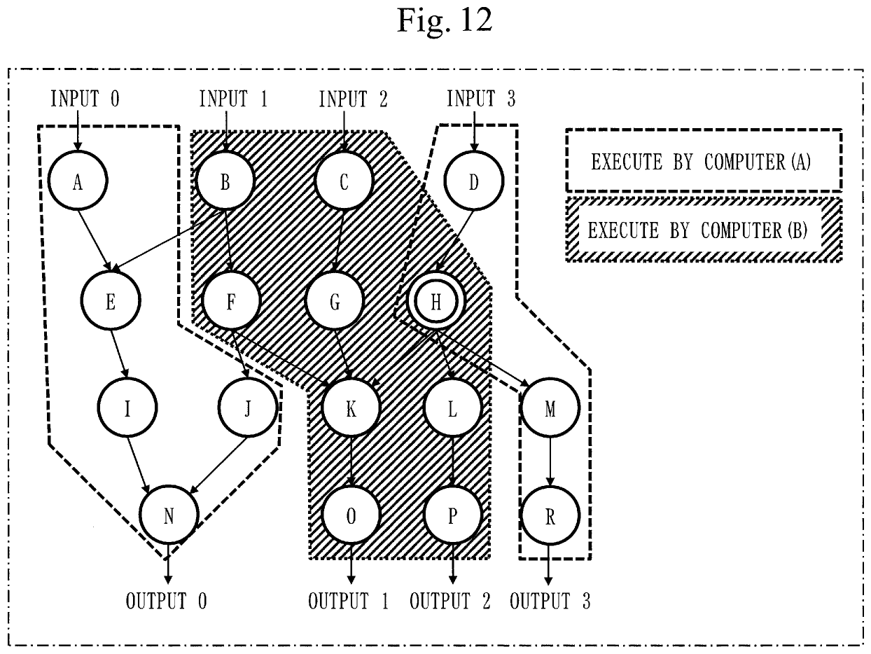

An example of the block candidate information 405 to be used when the apportioned execution scheme is selected is illustrated in FIG. 12.

Next, a process of step S541 and processes after step S541 in FIG. 17 will be described.

FIG. 17 illustrates details of step S54 in FIG. 4.

In step S541, the second division unit 504 divides the program code 102 into blocks according to the block candidate information 405.

Next, in step S542, the second division unit 504 determines whether or not the apportioned execution scheme is selected by the scheme selection unit 503.

When the apportioned execution scheme is not selected (NO in step S542), in step S543, the second division unit 504 outputs the program code (A) 112 and the program code (B) 122 which are obtained by the division.

On the other hand, when the apportioned execution scheme is selected (YES in step S542), the second division unit 504 generates the instruction execution control information 117 and the instruction execution control information 127 in step S544.

In an example illustrated in FIG. 12, the second division unit 504 generates the instruction execution control information 117 and the instruction execution control information 127 both indicating that the process (H) is apportioned between the computer (A) 110 and the computer (B) 120 when the condition that the result of the process (D) meets the criterion a is satisfied.

For example, the instruction execution control information 117 describes the process (H), as a dynamic execution portion. Additionally, the instruction execution control information 117 describes the condition that the result of the process (D) meets the criterion a, as the execution condition. Further, the instruction execution control information 117 describes execution of a first half portion of the process (H) by the computer (A) 110, as operation to be performed when the execution condition is satisfied. Additionally, the instruction execution control information 117 describes execution of all of the process (H) by the computer (A) 110, as operation to be performed when the execution condition is unsatisfied.

For example, the instruction execution control information 127 describes the process (H) as the dynamic execution portion. Additionally, the instruction execution control information 127 describes the condition that the result of the process (D) meets the criterion a, as the execution condition. Further, the instruction execution control information 127 describes execution of a last half portion of the process (H) by the computer (B) 120, as operation to be performed when the execution condition is satisfied. Additionally, the instruction execution control information 127 describes absence of execution of the process (H), as operation to be performed when the execution condition is unsatisfied.

Then, in step S545, the second division unit 504 outputs the program code (A) 112, the program code (B) 122, the instruction execution control information 117, and the instruction execution control information 127.

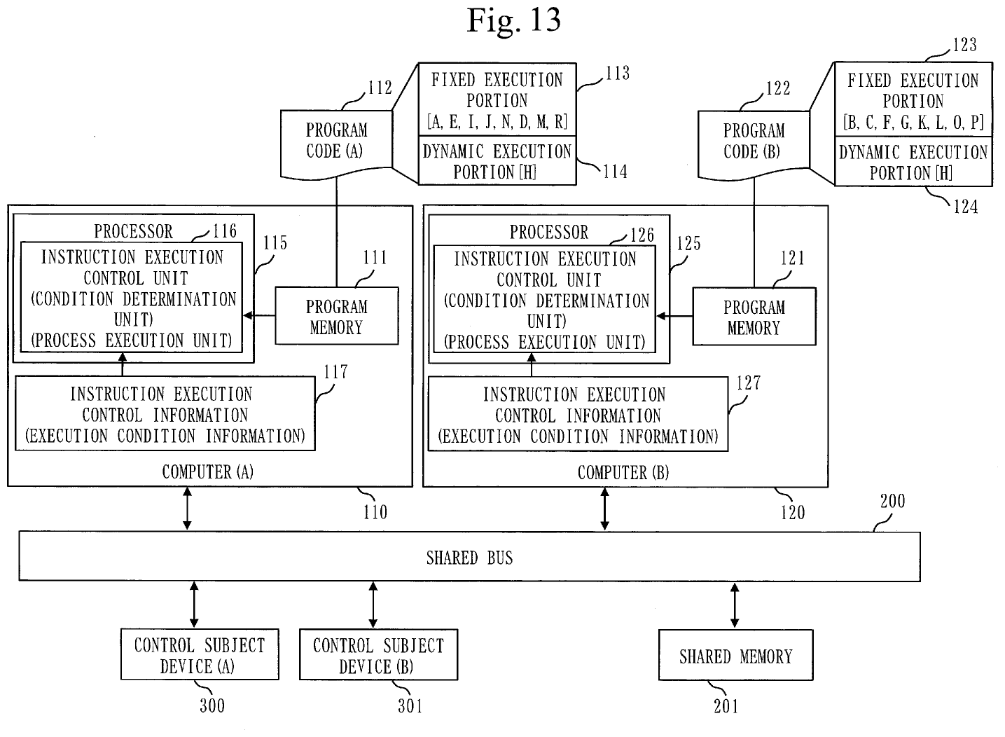

FIG. 13 illustrates an example in which an assignment result of the program code in FIG. 12 is described in the fixed execution portion 113, the dynamic execution portion 114, the fixed execution portion 123, and the dynamic execution portion 124 in FIG. 3.

That is, the processes (A, E, I, J, N, D, M, R) are described in the fixed execution portion 113, and the process (H) is described in the dynamic execution portion 114. On the other hand, the processes (B, C, F, G, K, L, O, P) are described in the fixed execution portion 123, and the process (H) is described in the dynamic execution portion 124.

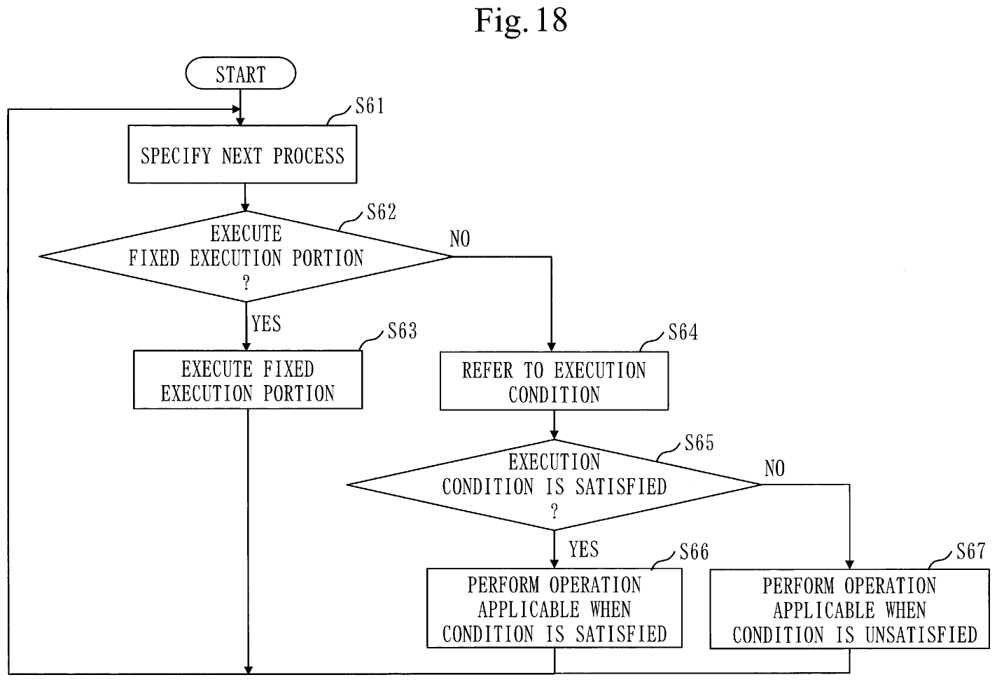

Next, an operation example of the computer (A) 110 and the computer (B) 120 will be described with reference to FIG. 18.

In the following, the operation example will be described as the operation of the computer (A) 110, but the following descriptions are also applied to the computer (B) 120.

First, in step S61, the instruction execution control unit 116 specifies a process to be executed next. Specifically, the instruction execution control unit 116 specifies the process to be executed next based on a value indicated in a program counter.

Next, in step S62, the instruction execution control unit 116 determines whether or not the process to be executed next is the fixed execution portion 113.

Specifically, the instruction execution control unit 116 determines whether or not the process to be executed next matches the process described as the dynamic execution portion in the instruction execution control information 117. When the process to be executed next does not match the process described as the dynamic execution portion in the instruction execution control information 117, the instruction execution control unit 116 determines that the process to be executed next is the fixed execution portion 113.

If the process to be executed next is the fixed execution portion 113 (YES in step S62), the process proceeds to step S63.

On the other hand, if the process to be executed next is not the fixed execution portion 113 (NO in step S62), the process proceeds to step S64.

In step S63, the instruction execution control unit 116 executes the next process which is the fixed execution portion 113.

In step S64, the instruction execution control unit 116 refers to the execution condition in the instruction execution control information 117.

Then, in step S65, the instruction execution control unit 116 determines whether or not the execution condition is satisfied.

When the execution condition is satisfied (YES in step S65), the process proceeds to step S66.

On the other hand, when the execution condition is unsatisfied (NO in step S65), the process proceeds to step S67.

In step S66, the instruction execution control unit 116 performs the operation applicable when the execution condition is satisfied. In the above example, the instruction execution control unit 116 executes the first half portion of the process (H).

In step S67, the instruction execution control unit 116 performs the operation applicable when the execution condition is unsatisfied. In the above-described example, the instruction execution control unit 116 executes an entire process (H).

### Description of Effect of Embodiment

As described above, in the present embodiment, when the coexistence process exists, the scheme with shorter execution time is selected between the parallel execution scheme and the shared execution scheme. Further, in the present embodiment, when the load variation process exists, the scheme with shorter execution time is selected between the single execution scheme and the apportioned execution scheme.

Therefore, according to the present embodiment, it is possible to realize efficient division of a program with a small overhead.

Further, in the present embodiment, each computer executes the program code divided as described above. Therefore, it is possible to control a control subject device efficiently with the small overhead.

### REFERENCE SIGNS LIST

100: computer, 101: program memory, 102: program code, 110: computer (A), 111: program memory, 112: program code (A), 113: fixed execution portion, 114: dynamic execution portion, 115: processor, 116: instruction execution control unit, 117: instruction execution control information, 120: computer (B), 121: program memory, 122: program code (B), 123: fixed execution portion, 124: dynamic execution portion, 125: processor, 126: instruction execution control unit, 127: instruction execution control information, 130: computer (C), 131: program memory, 132: program code (C), 200: shared bus, 201: shared memory, 300: control subject device (A), 301: control subject device (B), 302: control subject device (C), 401: computer information, 402: shared memory access ability information, 403: program execution order information, 404: output relation process information, 405: block candidate information, 500: program code assignment apparatus, 501: first division unit, 502: block candidate determination unit, 503: scheme selection unit, 504: second division unit, 901: processor, 902: main storage device, 903: auxiliary storage device, 904: communication device.

1. An information processing apparatus comprising:
processing circuitry
to divide a program into a plurality of block candidates, while permitting a part of processes in the program to coexist in two or more block candidates;
to determine whether or not the part of the processes in the program coexists in the two or more block candidates among the plurality of block candidates;
to compare, when the part of the processes in the program coexists in the two or more block candidates, an execution time to be taken when the program is executed in a parallel execution scheme with an execution time to be taken when the program is executed in a shared execution scheme, and select a scheme with shorter execution time between the parallel execution scheme and the shared execution scheme, the parallel execution scheme causing two or more computers being the same number as the two or more block candidates, to execute in parallel a coexistence process being the part of the processes in the program coexisting in the two or more block candidates, the shared execution scheme causing one computer among the two or more computers to execute the coexistence process and causing the other computer among the two or more computers to share an execution result of the one computer; and
to divide the program into a plurality of blocks based on the plurality of block candidates and the selected scheme.

2. The information processing apparatus according to claim 1,
wherein when the parallel execution scheme is selected, the processing circuitry divides the program into a plurality of blocks based on the plurality of block candidates so that the coexistence process is executed by the two or more computers in parallel, and
wherein when the shared execution scheme is selected, the processing circuitry divides the program into a plurality of blocks based on the plurality of block candidates so that the coexistence process is executed only by the one computer.

3. The information processing apparatus according to claim 1,
wherein the processing circuitry determines whether or not the program includes a load variation process which is a process whose execution time varies depending on a condition, and
wherein when the program includes the load variation process, the processing circuitry selects one of a single execution scheme causing one computer among a plurality of computers to execute the load variation process and an apportioned execution scheme apportioning the load variation process among the plurality of computers and causing the plurality of computers to execute the load variation process.

4. The information processing apparatus according to claim 3,
wherein the processing circuitry
compares for each condition, an execution time to be taken when the program is executed in the single execution scheme, with an execution time to be taken when the program is executed in the apportioned execution scheme, and
selects for each condition, a scheme with shorter execution time between the single execution scheme and the apportioned execution scheme.

5. The information processing apparatus according to claim 4,
wherein when the single execution scheme is selected for all conditions, the processing circuitry divides the program into a plurality of blocks based on the plurality of block candidates so that the load variation process is executed only by the one computer, and
wherein when the apportioned execution scheme is selected for one of the conditions, the processing circuitry divides the program into a plurality of blocks based on the plurality of block candidates so that the load variation process is apportioned among the plurality of computers and executed by the plurality of computers, and generates execution condition information defining as an execution condition, a condition for the load variation process to be apportioned among the plurality of computers and executed by the plurality of computers.

6. The information processing apparatus according to claim 1,
wherein when there exist a plurality of patterns each of which divides the program into the plurality of block candidates, the processing circuitry selects a pattern with the shortest execution time of the program among the plurality of patterns, and divides the program into the plurality of block candidates according to the selected pattern.

7. An information processing method comprising:
dividing a program into a plurality of block candidates, while permitting a part of processes in the program to coexist in two or more block candidates;
determining whether or not the part of the processes in the program coexists in the two or more block candidates among the plurality of block candidates;
comparing, when the part of the processes in the program coexists in the two or more block candidates, an execution time to be taken when the program is executed in a parallel execution scheme with an execution time to be taken when the program is executed in a shared execution scheme, and selecting a scheme with shorter execution time between the parallel execution scheme and the shared execution scheme, the parallel execution scheme causing two or more computers being the same number as the two or more block candidates, to execute in parallel a coexistence process being the part of the processes in the program coexisting in the two or more block candidates, the shared execution scheme causing one computer among the two or more computers to execute the coexistence process and causing the other computer among the two or more computers to share an execution result of the one computer; and
dividing the program into a plurality of blocks based on the plurality of block candidates and the selected scheme.

8. A non-transitory computer readable medium storing an information processing program which causes a computer to execute:
a first division process of dividing a program into a plurality of block candidates, while permitting a part of processes in the program to coexist in two or more block candidates;
a block candidate determination process of determining whether or not the part of the processes in the program coexists in the two or more block candidates among the plurality of block candidates;
a scheme selection process of comparing, when the part of the processes in the program coexists in the two or more block candidates, an execution time to be taken when the program is executed in a parallel execution scheme with an execution time to be taken when the program is executed in a shared execution scheme, and selecting a scheme with shorter execution time between the parallel execution scheme and the shared execution scheme, the parallel execution scheme causing two or more computers being the same number as the two or more block candidates, to execute in parallel a coexistence process being the part of the processes in the program coexisting in the two or more block candidates, the shared execution scheme causing one computer among the two or more computers to execute the coexistence process and causing the other computer among the two or more computers to share an execution result of the one computer; and
a second division process of dividing the program into a plurality of blocks based on the plurality of block candidates and the scheme selected by the scheme selection process.
